(19) United States
(12) Patent Application Publication
(10) Pub. No.: US 2014/0060588 A1
(43) Pub. Date: Mar. 6, 2014

(54) WASHING DEVICE FOR CLEANING PARTS, SUCH AS MACHINE PARTS OR THE LIKE

(71) Applicant: Robert Sporer, Zaulsdorf (DE)

(72) Inventor: Robert Sporer, Zaulsdorf (DE)

(21) Appl. No.: 13/872,565

(22) Filed: Apr. 29, 2013

(30) Foreign Application Priority Data
Sep. 1, 2012 (DE) 102012017377.6

(51) Int. Cl. B08B 3/02

(52) U.S. Cl. CPC B08B 3/02
USPC 134/110; 15/320

(57) ABSTRACT

The washing device for cleaning parts, such as machine parts or the like, characterized in that its housing has a circular cross-sectional shape, that its tank at a distance above the bottom of the washing device has a bottom wall with a central exit opening for the cleaning liquid which is connected by a line section to the suction opening of the pump arranged under the bottom wall, that a filter housing with a filter is inserted into the connection line, and that downstream of the filter housing a two-way distributor is inserted into the connection line from which a further line is branched off that leads through the wall of the housing into the tank and introduces the cleaning agent at said place into the tank in such a manner that the cleaning agent is put into rotation.

The present invention refers to a washing device for cleaning parts, such as oil-stained machine parts, without the invention being limited thereto. The washing device has a basket-like parts container or a wash basin which accommodates the parts to be cleaned, the parts basket being possibly arranged inside a washing cabinet having a preferably hinged lid, whereas the wash basin may be provided in an open form on the housing of the washing device. The parts container may be rotatably arranged about a vertical axis.

Furthermore, the washing device comprises a tank for cleaning liquid, which is preferably water which has a cleaning agent added thereto. Moreover, a pump is provided that sucks cleaning liquid from the tank and can supply said liquid via a connection line to a washing unit, which is at least a nozzle pipe arranged near the parts container, a washing gun or a spray brush.

It is the object of the present invention to indicate a washing device which shows a low energy consumption and in the case of which the cleaning liquid is freed automatically and efficiently of impurities, so that the cleaning liquid has only to be replaced after a long period of use.

This object is achieved according to the invention by the features of patent claim 1.

Advantageous developments of the invention are characterized in the sub-claims.

According to the invention the housing has a circular cross-sectional form. Preferably, the housing has the form of a circular cylinder with an upper wall which is preferably provided in the center with an opening above which the exit opening of the wash basin or the washing cabin is positioned. A coarse filter into which the cleaning liquid is falling that has been sprayed onto the parts to be cleaned is arranged under the central opening of the upper housing wall.

The cleaning liquid flows out of the coarse filter into the tank positioned in the housing, which tank at a distance above the bottom of the housing has a tank bottom wall with a central exit opening for the cleaning liquid which is connected through a line section to the suction opening of the pump which is arranged under the bottom wall. The chamber containing the pump is strongly heated by the operation of the pump.

The housing including its upper end wall is thermally insulated. The bottom wall of the tank with the central exit opening for the cleaning liquid does not have to be thermally insulated.

Furthermore, according to the invention a filter housing with a filter through which the pump presses the cleaning liquid is inserted into the connection line. Downstream of the filter housing, a distributor is inserted into the connection line and a line is branched off from said distributor, said line leading through the wall of the housing into the tank and introducing the cleaning agent at that place tangentially into the round tank in such a manner that the cleaning agent inside the tank is put into rotation.

In a washing process the cleaning liquid is supplied by the two-way distributor to the washing unit, and the cleaning liquid which is enriched with dirt particles falls through the coarse filter into the tank. The coarse filter retains the coarse impurities, but the cleaning liquid in the tank contains a multitude of fine dirt particles that are distributed in the tank.

After the washing operation has been completed, the pump is still operative, and the two-way distributor is now introducing the cleaning liquid laterally into the tank, with the cleaning agent in the tank being put into rotation. The dirt particles floating in the cleaning liquid are thereby gradually transported towards the center of the tank where they are collected above the suction opening of the pump and conveyed by the pump into the filter housing and through the filter cartridge arranged therein.

The cleaning liquid is thereby gradually freed almost entirely of dirt or foreign particles.

Surprisingly, in this process, which is carried out for several hours, the cleaning liquid is strongly heated. The cleaning liquid is heated to a temperature between about 48° C. and 70° C. after a pumping operation lasting for 4.5 to 6 hours, so that the washing device does not require any separate heater for the cleaning liquid. The heat originates from the pump on the one hand and its electric motor. With particular advantage it is provided in this connection that the pump outlet has connected thereto a metallic pipe which is strongly heated in the pump chamber. The pipe which preferably consists of stainless steel extends in spiral fashion to extend the route of the cleaning liquid through the “heating pipe” before it joins the connection line consisting e.g. of plastics.

Heating is intensified when the further line leading into the tank is connected in the tank to a circularly extending pipe which has a smaller inner diameter of about 3 to 10 mm and extends at least over half the circumferential wall of the tank. It has been found out in tests that the cleaning liquid under otherwise identical conditions is heated all the more the further the pipe is circularly extending. In the case of an extension over the whole circumference of the tank (near the circumferential wall thereof) a much higher temperature than in the case of an extension of the pipe over only half the circumference is achieved after the same process duration.

Since the cleaning liquid is pumped at a great pressure through the narrow pipe, it must be assumed that a frictional heat is here produced that will further heat the cleaning liquid.

The pump is preferably a rotary pump which has a capacity of about 0.1 kilowatt to about 3.0 kilowatts, depending on the size of the tank, which preferably contains 30-200 l of cleaning liquid.

The circularly extending pipe preferably consists of stainless steel.

The washing device according to the invention consumes very little energy. While in the inoperative washing mode the pump efficiently frees the cleaning liquid of all dirt particles to a high degree, the cleaning liquid is heated without any additional heating device.

Further details of the invention become apparent from the following description and from the drawings, in which:

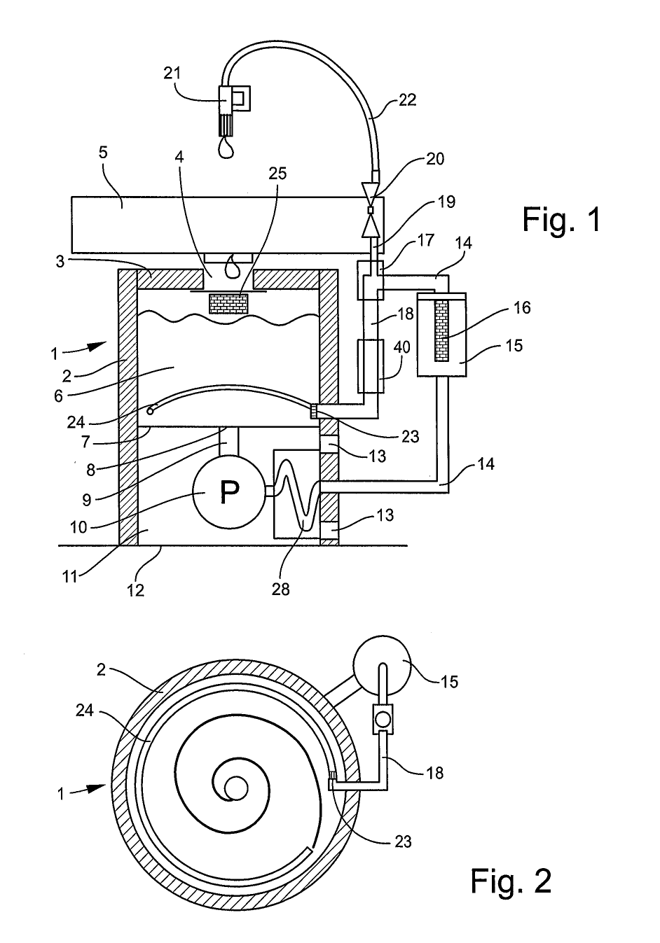

FIG. 1 is a purely schematic illustration of an embodiment of the washing device with a wash basin;

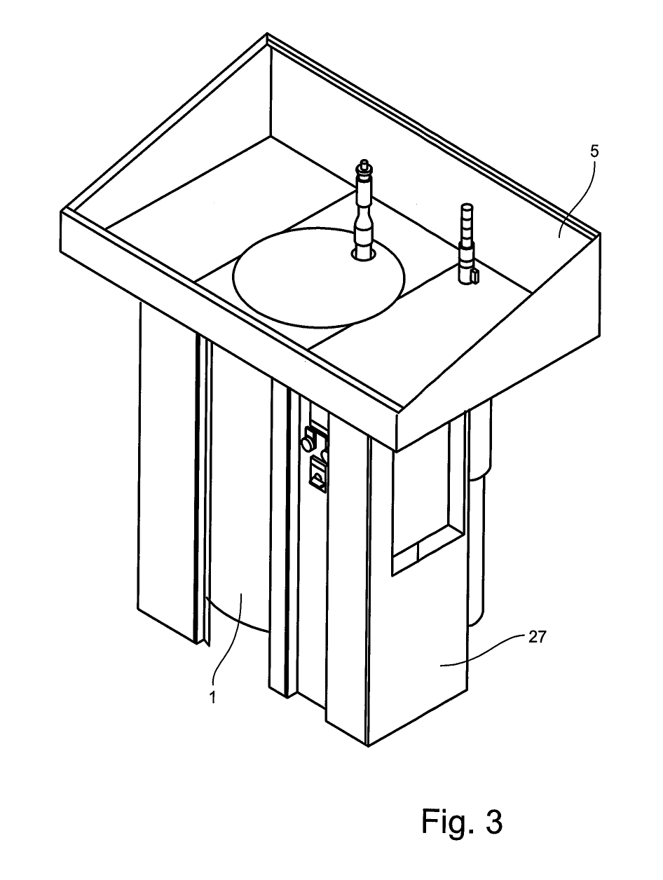

FIG. 2 is a purely schematic horizontal section through the washing device according to FIG. 1;

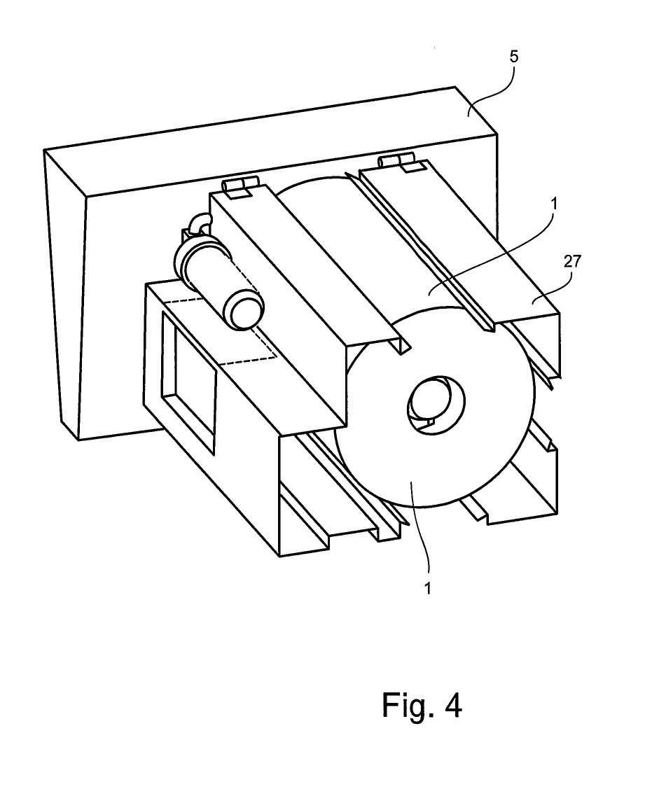

FIG. 3 is a perspective illustration of a washing device with wash basin;

FIG. 4 is a perspective view of the washing device according to FIG. 3 obliquely from below;

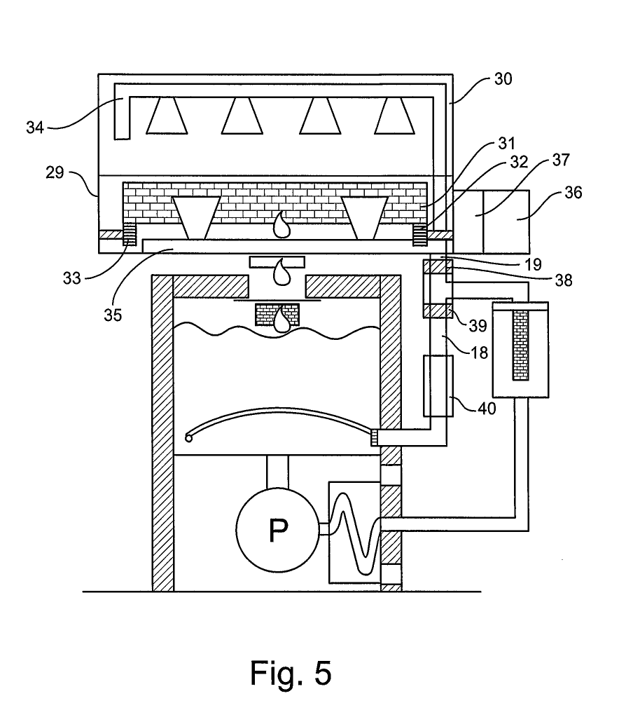

FIG. 5 is a purely schematic illustration of an embodiment with a basket-like parts container.

FIGS. 1 and 2 are mere diagrams showing a washing device including a thermally insulated housing 1 which contains a cylindrical circumferential wall 2 which is defined at the top by a wall 3 having a central opening 4. A wash basin 5 in which soiled parts are washed is arranged above the housing 1.

In its upper region the housing 1 contains a tank 6 which is defined at about half the height by a non-insulated wall 7 which contains a central exit opening 8 for the cleaning liquid. The exit opening 8 is connected by a pipe 9 to the suction opening of a pump 10 which is positioned in the chamber 11 under the tank 6. The chamber 11 is closed by a lower wall 12 and vented by way of slits 13 in the circumferential wall. A spirally extending stainless steel pipe 28 which is strongly heated in the pump chamber, which may reach a temperature of up to 65°, extends from the pressure side of the pump 10 to a connection line 14 which extends in a filter housing 15 having arranged therein a filter cartridge 16 through which the cleaning liquid is pressed. The connection line 14 extends from the outlet of the filter housing 15 to a manifold 17 where the line 14 branches off into a line 18 and a line 19. Each of the two lines 18, 19 may have arranged therein a valve for releasing the one or other line with the help of a control device. Instead of the two valves, a three-way valve may also be arranged.

The line 19 leads to a shut-off valve 20 for a washing gun 21 which is connected by means of a hose 22 to the shut-off valve.

The line 18 passes through the wall 2 of the tank 6 and contains a nozzle 23 at its end projecting into the interior of the tank 6. A pipe 24 which consists of steel and which extends at a small distance along the cylindrical circumferential wall 2 of the housing 1 is connected to the nozzle 23. The pipe 24 has a very small inner diameter of a few millimeters and is horizontally arranged in the tank 6. The pipe 24 extends over almost the entire circumference of the wall 2.

In a washing operation the cleaning liquid which is enriched with dirt particles falls into a coarse filter 25 which is arranged underneath the opening 4. Fine dirt particles pass with the cleaning liquid into the tank 6.

FIG. 2 shows that upon a rotating movement of the cleaning liquid the foreign particles are conveyed to the center of the tank 6 from where they are sucked off by the pump 10. These foreign particles are separated in the filter cartridge 16.

FIGS. 3 and 4 show a washing device with an open wash basin 5 which rests on a stand 27 including a plurality of support feet. The housing and the container 1, respectively, is fastened to the feet.

FIG. 5 only indicates the reference numerals that refer to components that are absent in the embodiment of FIGS. 1 and 2. Above the housing 1, the washing device of FIG. 5 contains a washing cabin 29 with a hinged lid 30. The washing cabin 29 has arranged therein a basket-like parts container 31 which rests with a lower sprocket on a driving gear 32 and free-running gears 33. An upper nozzle pipe 34 and a lower nozzle pipe 35 which are connected to the line 19 and direct cleaning liquid out of their nozzles onto the objects which are contained in the parts container 31 and are to be cleaned are arranged above and below the parts container 31. A drive motor 36 drives the drive gear 32 via a transmission 37. Solenoid valves 38 and 39 are provided for the lines 19 and 18.

Reference numeral 40 in FIGS. 1 and 5 designates a heater which may be provided in addition.

The washing device according to the invention is adapted to heat the cleaning medium with a very low energy input of the pump, use being here made of the heat of the pump chamber and the friction of the medium in the circular pipe in the tank. To achieve an efficient cleaning action, the pump must press the cleaning medium through the filter cartridge over a long period of time, resulting in the heat used for heating. The heating costs of conventional washing devices that have so far been high are thereby saved.

The nozzle located in the tank or the circularly extending nozzle pipe must here be adapted to the pump capacity.

Tests performed by the applicant have revealed that an energy saving of up to 60% in comparison with conventional devices is possible by using said heat.

1. A washing device for cleaning parts comprising: a housing, a wash basin or a basket-like parts container, a tank for cleaning liquid, and a pump which supplies cleaning liquid via a connection line from the tank to a washing unit which is either at least a nozzle pipe or a washing gun or a spray brush, the housing has a circular cross-sectional shape, the tank at a distance above a bottom of the washing device has a bottom wall with a central exit opening for the cleaning liquid which is connected by a line section to a suction opening of the pump arranged under the bottom wall, a filter housing with a filter is inserted into the connection line, and downstream of the filter housing a two-way distributor is inserted into the connection line from which a further line is branched off that leads through a wall of the housing into the tank and introduces a cleaning agent at said place into the tank in such a manner that the cleaning agent is put into rotation.

2. The washing device according to claim 1 wherein an outlet of the pump is in contact with an end of a pipe consisting of metal, which is connected with the other end to the connection line.

3. The washing device according to claim 2 wherein the pipe extends in a spiral fashion.

4. The washing device according to claim 1 wherein the further line is connected in the tank to a pipe which extends in substantially circular fashion and which has a smaller diameter than the line.

5. The washing device according to claim 4 wherein the further pipe extends near the circumferential wall of the tank at least over half the circumferential wall.

6. The washing device according to claim 5 wherein the pipe extends over a whole circumference or beyond.

7. The washing device according to claims 4 wherein a nozzle is arranged between the line and the pipe.

8. The washing device according to claims 4 wherein the inner diameter of the pipe is matched to the capacity of the pump.

9. The washing device according to claim 8 wherein the pipe has an inner diameter of 3 mm to 10 mm.

10. The washing device according to claim 8 wherein the pump is a rotary pump having a capacity of about 0.3 kilowatt to 2.2 kilowatts.

11. The washing device according to claims 1 wherein a control device for the valves by which the cleaning liquid is supplied either to the washing unit or directly to the tank.
